(19) United States
(12) Patent Application Publication
(10) Pub. No.: US 2026/0127555 A1
(43) Pub. Date: May 7, 2026

(54) DEVICE AND METHOD FOR SCHEDULING CHARGING AND DISCHARGING OF ELECTRIC VEHICLE

(71) Applicants: HYUNDAI MOTOR COMPANY, Seoul (KR); KIA CORPORATION, Seoul (KR)

(72) Inventors: Bum Su Park, Hwaseong-si (KR); Hyun Sup Kim, Hwaseong-si (KR); Min Kyu Lee, Hwaseong-si (KR); Jae Yun Jung, Hwaseong-si (KR); Na Yeon Park, Hwaseong-si (KR); Dae Gun Ko, Hwaseong-si (KR); Hye Seung Han, Hwaseong-si (KR); Sung Kyu Kim, Hwaseong-si (KR); Jeong Hoon Choi, Hwaseong-si (KR)

(73) Assignees: HYUNDAI MOTOR COMPANY, Seoul (KR); KIA CORPORATION, Seoul (KR)

(21) Appl. No.: 19/202,932

(22) Filed: May 8, 2025

(30) Foreign Application Priority Data
Nov. 1, 2024 (KR) 10-2024-0153326

(51) Int. Cl. G06Q 10/1093; B60L 53/63; B60L 53/68

(52) U.S. Cl. CPC G06Q 10/1097; B60L 53/63; B60L 53/68

(57) ABSTRACT

A device for scheduling charging and discharging of an electric vehicle is provided. The device includes a processor, and a memory to store a program executed by the processor. The processor includes a first processing unit to cluster registered electric vehicles, a second processing unit to distribute a contracted amount received from a demand management business operator server to each cluster, a third processing unit to generate a charging and discharging schedule of an electric vehicle using the contracted amount distributed to each cluster, a fourth processing unit to compare a voltage of a charger collected from a charger server with a preset reference voltage range and determine whether a voltage abnormality event occurs, and a fifth processing unit to adjust a charging and discharging schedule of a first cluster to which the first electric vehicle belongs when the voltage abnormality event occurs.

### CROSS-REFERENCE TO RELATED APPLICATION(S)

This application claims priority to and the benefit of Korean Patent Application No. 10-2024-0153326, filed on Nov. 1, 2024, the disclosure of which is incorporated herein by reference in its entirety.

### TECHNICAL FIELD

The present disclosure relates to a device and method for scheduling charging and discharging of an electric vehicle.

### BACKGROUND

As the spread of electric vehicles accelerates, research and business that utilize high-voltage batteries mounted on electric vehicles as an energy storage system (ESS) is increasing. The ESS may serve as an energy source and perform a vehicle-to-grid (V2G) function that supplies energy through charging and discharging in connection with a power system.

As a result, the management of charging and discharging scheduling of electric vehicles is being considered. Recently, as the spread and sales of electric vehicles increase, variables are increasing, which is causing representative problems such as increased computational dimensions, increased complexity, and increased (e.g., required) time.

However, V2G technology currently being applied does not consider the variability of electric vehicle charging and discharging on the basis of a distribution system and thus is insufficient to solve power quality problems resulting from the expansion of V2G services.

In addition, since a rapid increase in the amount of charging and discharging of electric vehicles is causing problems such as an undervoltage, overvoltage, and the like in the distribution system, it would be useful to have effective countermeasures to address such voltage fluctuation.

### SUMMARY

The present disclosure is directed to providing a device and method for scheduling charging and discharging of an electric vehicle, which considers voltage fluctuation occurring in a distribution system during the charging and discharging of the electric vehicle.

In addition, the present disclosure is directed to providing a device and method for scheduling charging and discharging of an electric vehicle, which are capable of (e.g., efficiently) managing power quality.

In addition, the load burden of a bus in which an undervoltage or an overvoltage is predicted may be reduced.

According to an aspect of the present disclosure, there is provided a device for scheduling charging and discharging of an electric vehicle, which includes one or more processors, and a memory configured to store one or more programs executed by the one or more processors. The processor may include a first processing unit configured to cluster registered electric vehicles, a second processing unit configured to distribute a contracted amount received from a demand management business operator server to each cluster of registered electric vehicles, a third processing unit configured to generate a charging and discharging schedule of an electric vehicle using the contracted amount distributed to each cluster, a fourth processing unit configured to compare a voltage of a charger collected from a charger server with a preset reference voltage range and determine whether a voltage abnormality event occurs, and a fifth processing unit configured to determine at least one first electric vehicle connected to a charger in which the voltage abnormality event occurs and adjust a charging and discharging schedule of at least one first cluster to which the first electric vehicle belongs.

The fifth processing unit may control the voltage of the charger to be included within the reference voltage range through the adjustment of the charging and discharging schedule.

The fifth processing unit may adjust the charging and discharging schedule while maintaining the contracted amount for each cluster.

The fourth processing unit may determine that an overvoltage event occurs when the voltage of the charger exceeds the reference voltage range.

When the overvoltage event occurs, the fifth processing unit may distribute at least some discharging amount of the first electric vehicle to a second electric vehicle belonging to the first cluster.

When the overvoltage event occurs, the fifth processing unit may distribute at least some charging amount of the second electric vehicle belonging to the first cluster to the first electric vehicle.

The fourth processing unit may determine that an undervoltage event occurs when the voltage of the charger is below the reference voltage range.

When the undervoltage event occurs, the fifth processing unit may distribute at least some discharging amount of the second electric vehicle belonging to the first cluster to the first electric vehicle.

When the undervoltage event occurs, the fifth processing unit may distribute at least some charging amount of the first electric vehicle to the second electric vehicle belonging to the first cluster.

When the fifth processing unit does not control the voltage of the charger to be included within the reference voltage range through the adjustment of the charging and discharging schedule, the fifth processing unit may adjust charging and discharging amounts of the first electric vehicle without maintaining the contracted amount for each cluster.

According to another aspect of the present disclosure, there is provided a method of scheduling charging and discharging of an electric vehicle, which is performed by a computing device including one or more processors and a memory configured to store one or more programs executed by the one or more processors, which includes performing, by the processor, clustering of registered electric vehicles, distributing, by the processor, a contracted amount received from a demand management business operator server to each cluster, generating, by the processor, a charging and discharging schedule of an electric vehicle using the contracted amount distributed to each cluster, comparing, by the processor, a voltage of a charger collected from a charger server with a preset reference voltage range and determining whether a voltage abnormality event occurs, and determining at least one first electric vehicle connected to a charger in which the voltage abnormality event occurs and adjusting a charging and discharging schedule of at least one first cluster to which the first electric vehicle belongs.

The adjusting of the charging and discharging schedule may include controlling the voltage of the charger to be included within the reference voltage range through the adjusting of the charging and discharging schedule.

The adjusting of the charging and discharging schedule may include adjusting the charging and discharging schedule while maintaining the contracted amount for each cluster.

The determining of whether the voltage abnormality event occurs may include determining that an overvoltage event occurs when the voltage of the charger exceeds the reference voltage range.

The adjusting of the charging and discharging schedule may include distributing at least some discharging amount of the first electric vehicle to a second electric vehicle belonging to the first cluster when the overvoltage event occurs.

The adjusting of the charging and discharging schedule may include distributing at least some charging amount of the second electric vehicle belonging to the first cluster to the first electric vehicle when the overvoltage event occurs.

The determining of whether the voltage abnormality event occurs may include determining that an undervoltage event occurs when the voltage of the charger is below the reference voltage range.

The adjusting of the charging and discharging schedule may include distributing at least some discharging amount of the second electric vehicle belonging to the first cluster to the first electric vehicle when the undervoltage event occurs.

The adjusting of the charging and discharging schedule may include distributing at least some charging amount of the first electric vehicle to the second electric vehicle belonging to the first cluster when the undervoltage event occurs.

The method may further include determining the voltage of the charger to be included within the reference voltage range through the adjusting of the charging and discharging schedule, and adjusting charging and discharging amounts of the first electric vehicle without maintaining the contracted amount for each cluster when the voltage of the charger is not included within the reference voltage range.

### BRIEF DESCRIPTION OF THE DRAWINGS

The above and other objects and features of the present disclosure may become more apparent to those of ordinary skill in the art through the description of the example embodiments herein and with reference to the accompanying drawings, in which:

FIG. 1 is a a system for managing power of an electric vehicle according to an example embodiment;

FIG. 2 is a configuration block diagram of a device for scheduling charging and discharging of an electric vehicle according to an example embodiment;

FIG. 3 is a view of the operations of a first processing unit and a second processing unit according to an example embodiment;

FIGS. 4 and 5 are diagrams illustrating an operation of a fifth processing unit according to an example embodiment;

FIGS. 6, 7, 8, and 9 are views of a process for adjusting a charging and discharging scheduling of the fifth processing unit according to an example embodiment; and

FIG. 10 is a flowchart illustrating a method of scheduling charging and discharging of an electric vehicle according to an example embodiment.

### DETAILED DESCRIPTION

Herein, example embodiments of the present disclosure will be described in detail with reference to the accompanying drawings.

The technical spirit of the present disclosure is not limited to the described embodiments, and may be implemented in various different forms. One or more of the components among the embodiments may be used by being (e.g., selectively) coupled or substituted without departing from the scope of the technical spirit of the present disclosure.

In addition, terms (including technical and scientific terms) used in embodiments of the present disclosure may be construed as providing that which may be generally understood by those skilled in the art to which the present disclosure pertains unless defined and described, and the meanings of the commonly used terms, such as terms defined in a dictionary, may be construed in consideration of contextual meanings of related technologies.

In addition, the terms used in the embodiments of the present disclosure are for describing the embodiments and are not intended to limit the present disclosure.

In the specification, a singular form may include a plural form unless otherwise specified in the phrase, and when described as “at least one (or one or more) of A, B, and C,” one or more among all possible combinations of A, B, and C may be included.

In addition, terms such as first, second, A, B, (a), and (b) may be used to describe components of the embodiments of the present disclosure.

These terms are for the purpose of distinguishing one component from another component, and the nature, sequence, order, or the like of the corresponding components is not limited by these terms.

In addition, when a first component is described as being “connected,” “coupled,” or “joined” to a second component, it may include a case in which the first component is directly connected, coupled, or joined to the second component, but also a case in which the first component is “connected,” “coupled,” or “joined” to the second component by another component present between the first component and the second component.

In addition, when the first component is described as being formed or disposed on “on (above) or below (under)” the second component, “on (above)” or “below (under)” may include not only a case in which two components are in direct contact with each other, but also a case in which one or more third components are formed or disposed between the two components. In addition, when described as “on (above) or below (under),” it may include the meaning of an upward direction and also a downward direction based on one component.

Hereinafter, embodiments will be described in detail with reference to the accompanying drawings, and the same or corresponding components are denoted by the same reference numeral regardless of the reference numerals, and overlapping descriptions thereof may be omitted.

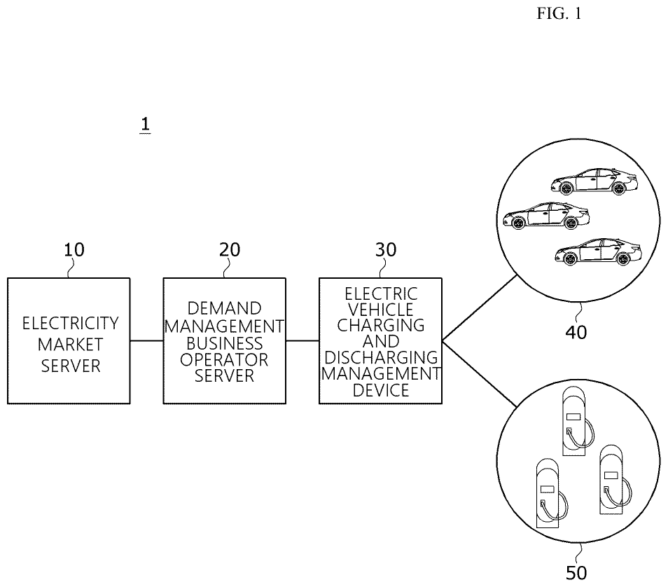

FIG. 1 is a view for describing a system for managing power of an electric vehicle according to an embodiment. Referring to FIG. 1, a system 1 for managing power of an electric vehicle may include a electricity market server 10, a demand management business operator server 20, and a device 30 for managing charging and discharging of an electric vehicle.

The electricity market server 10 is a main device that operates a power market and may perform settlement according to the participation amount of each resource in different ways according to market settlement rules. The electricity market server 10 may mediate power transactions between the demand management business operator servers 20 using power transaction request information received from a plurality of demand management business operator servers 20.

The electricity market server 10 may be a server that contracts with a demand management business operator to contract power usage and discharge business amount and distributes profits to the demand management business operator through demand response and a power unit price for each time period.

The demand management business operator server 20 may perform power transaction using charging and discharging information received from the connected device 30 for managing charging and discharging of an electric vehicle, renewable energy generation amount information of a connected renewable energy generation system, and power demand information of a connected system.

In an example embodiment, the demand management business operator may be a business operator who contracts with places that use a large amount of electricity, such as a factory, a big building, a parking tower, and the like to perform power consumption reduction or the like according to demand response, thus gaining profits.

The power system connected to the demand management business operator may transmit power demand information to the demand management business operator server 20 at a preset cycle, at the request of the demand management business operator server, or as needed. The power demand information may include the hourly power demand amount and the power usage reduction demand amount of the connected system.

The demand management business operator server 20 may not only respond to a demand response through a power usage reduction request, but also may serve as a power plant that reversely transmits electricity that may be used (e.g., directly) in the system using electric vehicles 40, electric vehicle batteries, an energy storage system (ESS), or the like.

For example, the demand management business operator server 20 may receive a next day's charging and discharging amount of the device 30 for managing charging and discharging of an electric vehicle at a specific time every day, bid the charging and discharging amount to the electricity market server side, receive the contracted amount from the electricity market server 10 according to the preset cycle, and transmit the contracted amount to the device 30 for managing charging and discharging of an electric vehicle.

The device 30 for managing charging and discharging of an electric vehicle may (e.g., directly) manage the electric vehicles 40, charging stations 50 of customers who participate in a vehicle to everything (V2X) service and receive information on the electric vehicles 40 and chargers, plug-in/out signals, and the like. The device 30 for managing charging and discharging of an electric vehicle may determine a next day's charging and discharging bid amount with the goal of maximizing market participation profits and control the charging and discharging of individual electric vehicles 40 to fulfill the contracted amount.

The device 30 for managing charging and discharging of an electric vehicle may monitor information on the electric vehicles 40 and the charging stations 50 and provide various data for customers. The device 30 for managing charging and discharging of an electric vehicle may perform functions of settling bills, managing a parking space, generating and transmitting charging and discharging control instructions, controlling charging and discharging scenarios, diagnosing a battery state of a vehicle, and the like.

The device 30 for managing charging and discharging of an electric vehicle may include a controller 31.

The power system may include, for example, a smart grid-related system such as a substation, an electricity market server, a demand management business operator server, renewable sources, an ESS, and the like. The renewable energy sources may be energy sources using wind power, solar power, geothermal heat, waste, and the like. The power system may supply power within allowable power (or maximum power) Pmax (or allowable AC current IA Cmax) range to the charging stations 50 under the control of the controller 31.

In some cases, when a plurality of electric vehicles 40 are concentrated on the charging stations 50 in a specific region at the same time, the maximum allowable power of the power system may vary. That is, the electricity market server 10, the demand management business operator server 20 or an energy management system (EMS) that controls the operation of the power system may increase the power capacity by inputting a reserve power source such as an ESS or a nearby renewable energy source and supply the increased power capacity to the charging stations.

The allowable power may be increased under the control of the controller 31 when the power supplied to the electric vehicles 40 is insufficient due to the charging demand information of each electric vehicle 40 (charging demand amounts of electric vehicle users). That is, the controller 31 may control a switch to additionally connect (input) a renewable energy source (or an ESS) within the power system to a substation that supplies power to the charging stations 50 so that the allowable power of the power system increases when a charging load (a load of the electric vehicle) of the charging station 50 exceeds the allowable power of the power system.

The controller 31 may control the overall operation of the components included in the device 30 for managing charging and discharging of an electric vehicle. The controller 31 is an aggregator and may collect the battery capacity of the electric vehicle 40 connected to the charging station 50 through a wired or wireless communication network, a state of charge (SoC) of the battery of the electric vehicle 40, a rated current flowing through a power line, a rated voltage applied to the power line, or the charging demand information of an electric vehicle user (e.g., an owner). The charging demand information of the electric vehicle user may be transmitted to the controller 31 through a communication device included in each of the charging stations 50 or transmitted to the controller 31 through a communication device such as a user's portable phone.

The controller 31 may exchange information with the power system through a wired or wireless communication network and exchange data with the charging station 50 through a LAN connection such as Ethernet, power line communication (PLC), or Wi-Fi, which is a wired or wireless communication network.

Based on real-time information of the power system, state information of the electric vehicle 40, and charging demand information of each electric vehicle 40, the controller 31 may control the power of the power system to be supplied to the charging station 50 within the allowable power range of the power system.

The real-time information of the power system may include the allowable power information of the power system or the electricity rate information of the power system. The state information of the electric vehicle 40 may include the SoC information of the battery included in each electric vehicle 40. The charging demand information may include a charging demand time of an electric vehicle user, a scheduled vehicle entry time, a scheduled vehicle exit time, and a charging demand amount (a target SoC).

The charging station 50 may charge the batteries of the plurality of electric vehicles 40. Each of the charging stations 50 may include an AC limiter that performs a current allocation operation for each electric vehicle 40. In addition, each of the charging stations 50 may include a battery management system (BM S) of the electric vehicle 40 and a control module for exchanging information with the controller 31. Under the control of the controller 31, the control module may control the current limiter (the A C limiter) to provide a DC charging current to the battery of each of the electric vehicles 40.

Each of the electric vehicles 40 may include a BMS. The BMS may control a battery charging process. Each of the electric vehicles 40 may serve as an active load that requests power from the device 30 for managing charging and discharging of an electric vehicle for a charging time.

A charger for converting an AC current into a DC current of the power system to charge the battery of the electric vehicle 40 may be an on-board charger included in each of the electric vehicles 40 or an off-board charger included in each of the charging stations 50.

The electric vehicle 40 may register on a V2X platform and participate in power trading. A user of the electric vehicle 40 may join the platform according to the power market in which he or she wants to participate and register a predicted entry and exit schedule for the next day. The electric vehicle 40 may transmit information, such as a predicted plug-in time, a predicted plug-out time, SoC information, available battery capacity, and the like to the device 30 for managing charging and discharging of an electric vehicle.

The system 1 for managing power of an electric vehicle is a centralized control system and may adjust charging and discharging schedules of electric vehicles considering the hourly power price, the demand and supply of the power system, or the like. However, as the number of electric vehicles that are a control target increases, the amount of calculation and complexity for optimal scheduling increase.

The device for scheduling charging and discharging of an electric vehicle according to an example embodiment may (e.g., technically) optimize the charging and discharging of a large-scale electric vehicle fleet. The device for scheduling charging and discharging of an electric vehicle according to the embodiment may be included in the configuration of the electric vehicle charging and discharging management device or provided as a separate device. When the device for scheduling charging and discharging of an electric vehicle is provided as a separate device, a separate wired or wireless communication device may be provided to communicate with an electric vehicle, an external server, a terminal, and the like.

An example embodiment in which the device for scheduling charging and discharging of an electric vehicle is to be included in the device 30 for managing charging and discharging of an electric vehicle of FIG. 1 will be described.

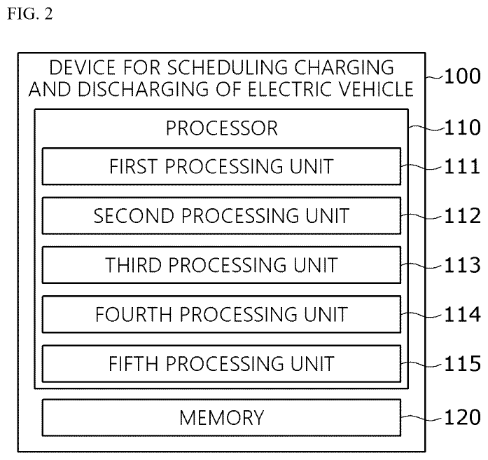

FIG. 2 is a configuration block diagram of a device for scheduling charging and discharging of an electric vehicle according to an example embodiment.

Referring to FIG. 2, the device 100 for scheduling charging and discharging of an electric vehicle may include a processor 110 and a memory 120. In addition, the processor 110 according to the embodiment may include a first processing unit 111, a second processing unit 112, a third processing unit 113, a fourth processing unit 114, and a fifth processing unit 115.

The device 100 for scheduling charging and discharging of an electric vehicle according to the example embodiment may be implemented in a logic circuit by hardware, firmware, software, or a combination thereof and may also be implemented using a general-purpose or special-purpose computer. The device may be implemented using a hardwired device, a field programmable gate array (FPGA), an application specific integrated circuit (ASIC), and the like. In addition, the device 100 for scheduling charging and discharging of an electric vehicle may be implemented as a SoC including one or more processors and controllers.

In addition, the device 100 for scheduling charging and discharging of an electric vehicle may be mounted on a computing device or server, which is provided with hardware elements and in which software, hardware, or a combination thereof is installed. The computing device or the server may be various devices including all or some of a communication device such as a communication modem for communicating with various devices or wired and wireless communication networks, a memory in which data for executing a program is stored, a microprocessor for executing a program to perform calculations and instructions, and the like.

The memory 120 may include a database (DB). The memory 120 may be a non-transitory storage medium for storing instructions executed by the processor. The memory 120 may include at least one of a random access memory (RAM), a static random access memory (SRAM), a read only memory (ROM), a programmable read only memory (PROM), an electrically erasable and programmable ROM (EEPROM), an erasable and programmable ROM (EPROM), a hard disk drive (HDD), a solid state disk (SSD), an embedded multimedia card (eMMC), a universal flash storage (UFS), and/or a web storage.

In an embodiment, the first processing unit 111 to the fifth processing unit 115 may be implemented through the same process, and for convenience of description, the operation of each component is provided herein separately.

The processor 110 may include at least one of processing devices (e.g., an ASIC, a digital signal processor (DSP), a programmable logic device (PLD), an FPGA), a central processing unit (CPU), a microcontroller, and/or a microprocessor.

The first processing unit 111 may cluster registered electric vehicles. The first processing unit 111 may cluster a plurality of electric vehicles according to charging and discharging conditions for each time slot and generate at least one electric vehicle group. The time slot may be a preset time interval, and the same time interval may be present between time slots.

The first processing unit 111 may collect battery capacities of electric vehicles, charging states of batteries of electric vehicles, rated currents flowing through power lines, a rated voltage applied to the power lines, or charging and discharging conditions of electric vehicles through a communication device. The charging and discharging conditions of the electric vehicles may include information such as a predicted SoC, a predicted plug-in time, a predicted plug-out time, and/or the like. The charging and discharging conditions of the electric vehicles may be transmitted to the first processing unit 111 through a communication device included in each of the charging stations or transmitted to the first processing unit 111 through a communication device such as the user's portable phone.

The first processing unit 111 may cluster a plurality of electric vehicles according to the charging and discharging conditions. The first processing unit 111 may cluster the plurality of electric vehicles using a K-means clustering algorithm according to a preset number of electric vehicles per cluster.

K-means clustering is a method of unsupervised learning and is a technique for dividing given data into k clusters. Such an algorithm may assign each data point to the nearest centroid to form a cluster and optimize the quality of clustering by repeatedly recalculating the centroid of each cluster.

The first processing unit 111 may preset the number of clusters k according to the preset number of electric vehicles per cluster. The first processing unit 111 may randomly select k centroids from a dataset and assign each data point to the nearest centroid to form a cluster. In this case, the data point may be set according to the charging and discharging conditions of the electric vehicle. For example, the data point may be determined to be three-dimensional coordinates according to a predicted SoC, a predicted plug-in time, and a predicted plug-out time. The first processing unit 111 may determine the nearest centroid using a distance such as a Euclidean distance.

The first processing unit 111 recalculates the centroid of each cluster as an average of data points belonging to the corresponding cluster and repeats such a process until the centroid no longer changes or the cluster assignment converges.

When the centroids do not change or the maximum number of repetitions is reached, the first processing unit 111 may end the algorithm and return the final cluster and the centroids.

The second processing unit 112 may distribute the contracted amount received from the demand management business operator server for each cluster. The second processing unit 112 may distribute the contracted amount received from the demand management business operator server equally for each cluster.

The device for scheduling charging and discharging of an electric vehicle according to the example embodiment bids a charging and discharging amount for each time period for 24 hours of a contracted day on the day before the contracted day and receives the contracted amount every hour of the contracted day. Each charging and discharging platform may derive and control a charging or discharging schedule for each electric vehicle according to the contracted amount.

The second processing unit 112 may distribute the contracted amount to the electric vehicles so that the electric vehicles may perform the contracted amount received from the electricity market server every hour. In this case, since the second processing unit 112 performs charging and discharging scheduling for each group, the second processing unit 112 distributes the contracted amount to each group.

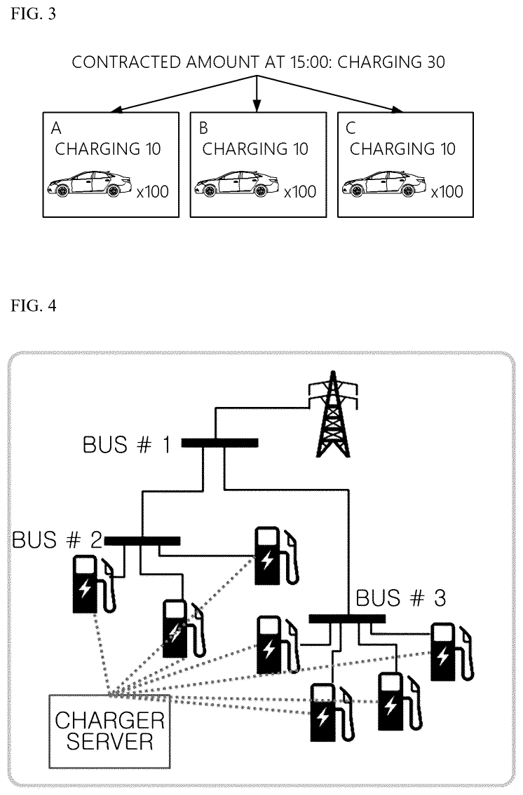

FIG. 3 is a view of the operations of a first processing unit and a second processing unit according to an embodiment.

Referring to FIG. 3, the first processing unit 111 may cluster the registered electric vehicles into three clusters: A, B, and C. The second processing unit 112 may distribute contracted amount charging, such as 30 [kWh], received from the demand management business operator server to three clusters according to the same charging amount, such as [10 kWh].

The third processing unit 113 may generate charging and discharging schedules of an electric vehicle using the contracted amount distributed to each cluster. The third processing unit 113 may generate charging and discharging schedules so that profits of electric vehicles belonging to the corresponding cluster are maximized according to the contracted amount for each cluster. The third processing unit 113 may output a signal for controlling the charging and discharging of an individual electric vehicle according to the generated charging and discharging schedules.

The third processing unit 113 may set the charging and discharging schedules of the individual electric vehicle belonging to each cluster using the contracted amount of the electric vehicle for each cluster. The third processing unit 113 may subdivide the charging and discharging schedules of the individual electric vehicle belonging to each cluster based on the contracted amount distributed based on the cluster. In this case, the charging and discharging schedules may be set considering individual operating conditions of each electric vehicle. That is, the charging and discharging schedules may be the charging and discharging schedules of the individual electric vehicle belonging to the cluster.

In an example embodiment, various objective functions may be applied for optimal charging and discharging scheduling. For example, goals such as minimizing an electricity cost, maximizing a battery lifetime, optimizing a load of a power grid, and the like may be applied.

For example, the third processing unit 113 may set the charging and discharging schedules to follow a target battery capacity of the individual electric vehicle based on the contracted amount for each cluster. The third processing unit 113 may set the charging and discharging schedules so that the sum of charging and discharging amounts of the individual electric vehicle in the cluster through the charging and discharging schedules is equal to the contracted amount for each cluster.

The charging and discharging schedules may include the charging power amount and the discharging power amount of the individual electric vehicle for each cluster. In this case, the third processing unit 113 may determine the charging and discharging power amounts of the individual electric vehicle to follow the target SoC of the individual electric vehicle. The third processing unit 113 may set the charging and discharging schedules so that a difference value between the SoC of the electric vehicle and the target SoC after actual charging or discharging according to the charging and discharging schedules is a minimum value. In this case, the third processing unit 113 may set an SoC upper limit value and an SoC lower limit value according to an available capacity range of a battery of the individual electric vehicle and set the charging and discharging schedules so that the electric vehicle may be charged and discharged within the range of the SoC upper limit value and the SoC lower limit value.

For example, the third processing unit 113 may set the difference value between the SoC of the electric vehicle after the charging and discharging control and the target SoC to an objective function and minimize the difference value through an optimization process of the set objective function.

Alternatively, the third processing unit 113 may set the charging and discharging schedules so that the profit through the sum of the charging fee and the discharging profit is maximized. For example, the third processing unit 113 may set a price obtained by summing a price of purchasing power for charging after charging and discharging control and a price of selling power through discharging to the objective function and minimize the difference value through the optimization process of the set objective function.

The third processing unit 113 may optimize the objective function by adapting a gradient descent method, a steepest descent method, or a stochastic gradient descent method.

The fourth processing unit 114 may compare a voltage of a charger collected from a charger server with a preset reference voltage range and determine whether a voltage abnormality event occurs. In an example embodiment, the reference voltage may be set based on a nominal voltage. For example, the fourth processing unit 114 may set a tolerance range of 6% based on the nominal voltage of 220 [V] and set 207 [V] to 233 [V] to the reference voltage range.

The fourth processing unit 114 may monitor a collected input voltage for each charger through a database unit, and when the voltage is out of a predetermined range, fetch the fifth processing unit 115 to adjust the charging and discharging schedules.

The voltage information of the charger is collected through the charger server such as E-pit, and the collected data may be received by a communication unit and stored in the database unit. In an example embodiment, the voltage information of the charger may include a charger input voltage, a charger unique number, and information on an electric vehicle plugged-in the charger.

For example, the fourth processing unit 114 may determine that an overvoltage event occurs when the voltage of the charger exceeds the reference voltage range.

Alternatively, the fourth processing unit 114 may determine that an undervoltage event occurs when the voltage of the charger is below the reference voltage range.

Since the nominal voltage, which is one of evaluation criteria for power quality, varies locally, generally, a current is reduced when an electric load is reduced, thereby increasing the nominal voltage.

The fifth processing unit 115 may determine that when at least one first electric vehicle connected to a charger has the voltage abnormality event occur, the fifth processing unit 115 may adjust charging and discharging schedules of at least one first cluster to which the first electric vehicle belongs. As described above, the voltage abnormality event may include an undervoltage event and an overvoltage event. When a voltage event occurs, the fifth processing unit 115 may recognize a charger unique number included in the charger voltage information and information on the first electric vehicle plugged-in the charger and determine first cluster information using the information on the first electric vehicle. The first electric vehicle may include one or more electric vehicles. The first cluster may be provided as one or more first clusters. That is, when the voltage abnormality event occurs, when one first electric vehicle connected to the corresponding charger is present, the first cluster to which the first electric vehicle belongs may be provided as one first cluster. Alternatively, when a plurality of first electric vehicles are present, the first cluster to which the first electric vehicle belongs may be provided as a plurality of first clusters.

The fifth processing unit 115 may adjust the charging and discharging schedules to control the voltage of the charger to be included within the reference voltage range. That is, the fifth processing unit 115 may distribute the charging and discharging amounts of the first electric vehicle to at least one second electric vehicle belonging to the first cluster to control the charging and discharging amounts of the voltage of the charger to which the first electric vehicle is connected. Accordingly, the voltage of the charger may be adjusted to be within the reference voltage range.

In this case, the fifth processing unit 115 may adjust the charging and discharging schedule while maintaining the contracted amount for each cluster. That is, the fifth processing unit 115 may adjust the charging and discharging schedules so that the sum of the charging and discharging amounts of the first electric vehicle and the charging and discharging amounts of the second electric vehicle is the contracted amount of the first cluster.

However, when the voltage of the charger is not included within the reference voltage range, the fifth processing unit 115 may adjust the charging and discharging amounts of the first electric vehicle without maintaining the contracted amount for each cluster. When the fifth processing unit 115 does not adjust the voltage of the charger to be within the reference voltage range, the fifth processing unit 115 may adjust the charging and discharging amounts of the first electric vehicle regardless of the contracted amount for each cluster and control the voltage of the charger to be within the reference voltage range.

For example, when only one or more first electric vehicles are present in the first cluster, the fifth processing unit 115 may not distribute the charging and discharging amounts of the first electric vehicle to the second electric vehicle. In this case, the fifth processing unit 115 may (e.g., forcibly) adjust the charging and discharging amounts of the first electric vehicle without complying with the contracted amount of the first cluster and control the voltage of the charger to be within the reference voltage range.

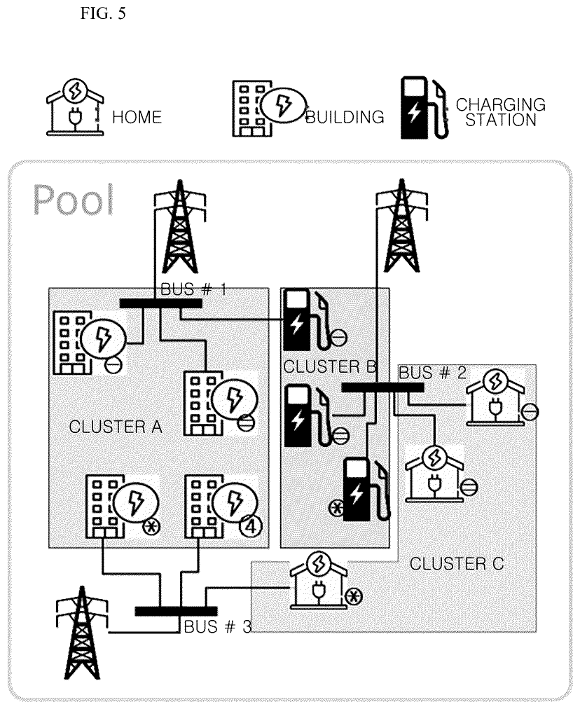

FIGS. 4 and 5 are diagrams of an operation of a fifth processing unit according to an example embodiment. Referring to FIG. 4 chargers are installed in a home, a building, and a charging station and are connected to distribution lines through buses. Accordingly, voltages of the chargers connected to the distribution lines through the buses may impact (e.g., affect) each other.

For convenience of description, in FIG. 5, an example in which one charger is installed at each position and one electric vehicle is connected to each charger will be described. Referring to FIG. 5, four electric vehicles a, b, c, and d belonging to Cluster A are plugged-in first to fourth chargers, respectively, three electric vehicles e, f, and g belonging to Cluster B are plugged-in fifth to seventh chargers, respectively, and three electric vehicles h, i, and j belonging to Cluster C are plugged-in eighth to tenth chargers, respectively.

In addition, Bus #1 is connected to the first charger, the second charger, and the fifth charger, the sixth charger, Bus #2 is connected to the seventh charger, the eighth charger, and the ninth charger, and Bus #3 is connected to the third charger, the fourth charger, and the tenth charger.

For example, when a voltage of Bus #1 temporarily drops and an undervoltage event occurs while the first charger, the second charger, and the fifth charger are being charged, the fifth processing unit 115 may adjust charging and discharging schedules of Cluster A of electric vehicles plugged-in the first charger and the second charger and charging and discharging schedules of Cluster B of electric vehicles plugged-in the fifth charger.

The fifth processing unit 115 may distribute some of the charging and discharging amounts of the electric vehicles a and b connected to the first charger and the second charger in Cluster A to the electric vehicles c and d connected to the third charger and the fourth charger and distribute some of the charging and discharging amounts of the electric vehicle e connected to the fifth charger in Cluster B to the electric vehicles f and g connected to the sixth charger and the seventh charger. Accordingly, the fifth processing unit 115 may resolve the undervoltage event and adjust voltages of the first charger, the second charger, and the fifth charger to be within the reference voltage range.

In this case, the fifth processing unit 115 may adjust the charging and discharging schedules so that the cluster-specific contracted amounts of Cluster A and Cluster B are maintained. That is, before and after the adjustment of the charging and discharging schedules, a total of the charging and discharging schedules of the electric vehicles a, b, c, and d plugged-in the first to fourth chargers needs to be equal to the contracted amount of Cluster A, and a total of the charging and discharging schedules of the electric vehicles e, f, and g plugged-in the fifth to seventh chargers need to be equal to the contracted amount of Cluster B.

For example, when an overvoltage event occurs, the fifth processing unit 115 may distribute at least some of the discharging amount of the first electric vehicle to the second electric vehicle belonging to the first cluster. That is, when the overvoltage event occurs, the voltage of the charger connected to the first electric vehicle may be reduced by reducing the discharging amount of the first electric vehicle.

For example, when the overvoltage event occurs, the fifth processing unit 115 may distribute at least some of the charging amount of the second electric vehicle belonging to the first cluster to the first electric vehicle. That is, when the overvoltage event occurs, the voltage of the charger connected to the first electric vehicle may be reduced by increasing the charging amount of the first electric vehicle.

For example, when an undervoltage event occurs, the fifth processing unit 115 may distribute at least some of the discharging amount of the second electric vehicle belonging to the first cluster to the first electric vehicle. That is, when the undervoltage event occurs, the voltage of the charger connected to the first electric vehicle may be increased by increasing the discharging amount of the first electric vehicle.

For example, when the undervoltage event occurs, the fifth processing unit 115 may distribute at least some of the charging amount of the first electric vehicle to the second electric vehicle belonging to the first cluster. That is, when the undervoltage event occurs, the voltage of the charger connected to the first electric vehicle may be increased by reducing the charging amount of the first electric vehicle.

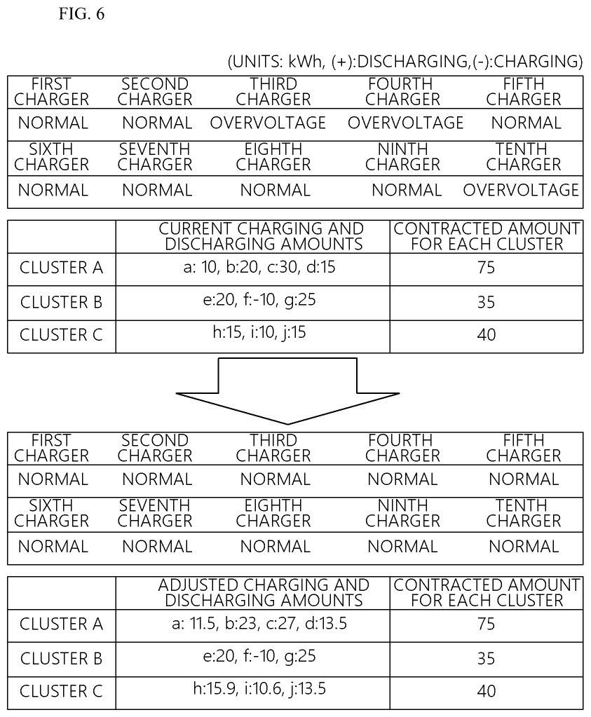

FIGS. 6, 7, 8, and 9 are provide a process of adjusting charging and discharging scheduling of the fifth processing unit according to an embodiment.

In FIGS. 6 to 9, contracted amounts distributed to Clusters A, B, and C are discharging 75 [kWh], discharging 35 [kWh], and discharging 40 [kWh], respectively, the nominal voltage is 220 [V], the reference voltage range ranges from 207 [V] to 233 [V], and a schedule adjustment ratio may be set to 90%.

Referring to FIG. 6, the fourth processing unit 114 may determine that the overvoltage event occurs in the third charger, the fourth charger, and the tenth charger that are connected to Bus #3. The fifth processing unit 115 may check electric vehicle information connected to the third and fourth chargers and a cluster to which the third and fourth chargers belong and adjust the charging and discharging schedules of the electric vehicles belonging to Cluster A. In addition, the fifth processing unit 115 may check electric vehicle information connected to the tenth charger and a cluster to which the tenth charger belongs and adjust the charging and discharging schedules of the electric vehicles belonging to Cluster C.

The fifth processing unit 115 distributes some of the discharging amounts of the electric vehicles c and d connected to the third and fourth chargers to the electric vehicles a and b connected to the first and second chargers. In addition, the fifth processing unit 115 distributes some of the discharging amount of the electric vehicle j connected to the tenth charger to the electric vehicles h and i connected to the eighth and ninth chargers.

After adjusting the charging and discharging schedules, the fifth processing unit 115 checks whether the voltages of the first to tenth chargers are included within the reference voltage range and whether the contracted amount for each cluster is satisfied.

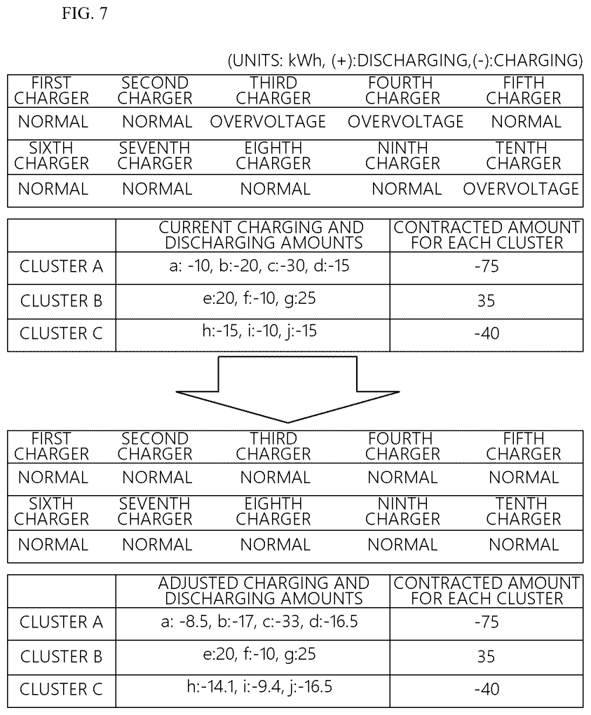

Referring to FIG. 7, the fourth processing unit 114 may determine that the overvoltage event occurs in the third charger, the fourth charger, and the tenth charger that are connected to Bus #3. The fifth processing unit 115 may check electric vehicle information connected to the third and fourth chargers and a cluster to which the third and fourth chargers belong and adjust the charging and discharging schedules of the electric vehicles belonging to Cluster A. In addition, the fifth processing unit 115 may check electric vehicle information connected to the tenth charger and a cluster to which the tenth charger belongs and adjust the charging and discharging schedules of the electric vehicles belonging to Cluster C.

The fifth processing unit 115 distributes parts of the charging amounts of the electric vehicles a and b connected to the first and second chargers to the electric vehicles c and d connected to the third and fourth chargers. In addition, the fifth processing unit 115 distributes parts of the discharging amounts of the electric vehicles h and i connected to the eighth and ninth chargers to the electric vehicle j connected to the tenth charger.

After adjusting the charging and discharging schedules, the fifth processing unit 115 checks whether the voltages of the first to tenth chargers are included within the reference voltage range and whether the contracted amount for each cluster is satisfied.

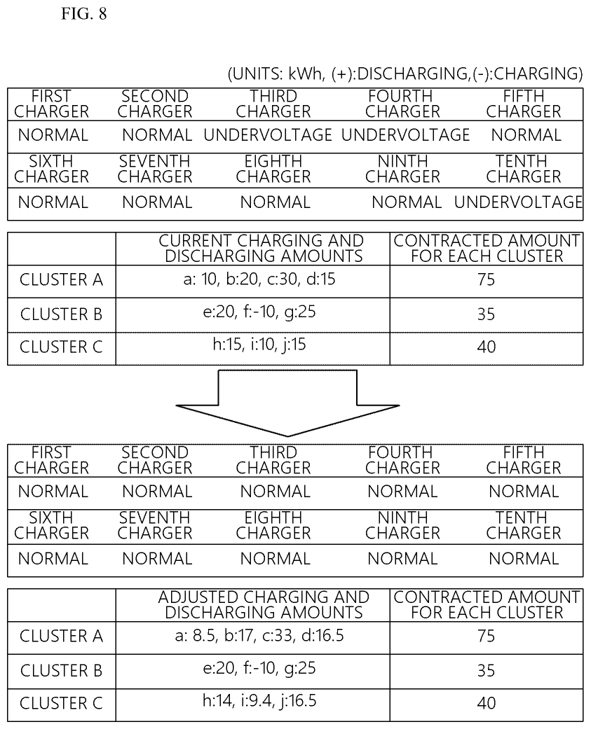

Referring to FIG. 8 together, the fourth processing unit 114 may determine that the undervoltage event occurs in the third charger, the fourth charger, and the tenth charger that are connected to Bus #3. The fifth processing unit 115 may check electric vehicle information connected to the third and fourth chargers and a cluster to which the third and fourth chargers belong and adjust the charging and discharging schedules of the electric vehicles belonging to Cluster A. In addition, the fifth processing unit 115 may check electric vehicle information connected to the tenth charger and a cluster to which the tenth charger belongs and adjust the charging and discharging schedules of the electric vehicles belonging to Cluster C.

The fifth processing unit 115 distributes parts of the discharging amounts of the electric vehicles a and b connected to the first and second chargers to the electric vehicles c and d connected to the third and fourth chargers. In addition, the fifth processing unit 115 distributes parts of the discharging amounts of the electric vehicles h and i connected to the eighth and ninth chargers to the electric vehicle j connected to the tenth charger.

After adjusting the charging and discharging schedules, the fifth processing unit 115 checks whether the voltages of the first to tenth chargers are included within the reference voltage range and whether the contracted amount for each cluster is satisfied.

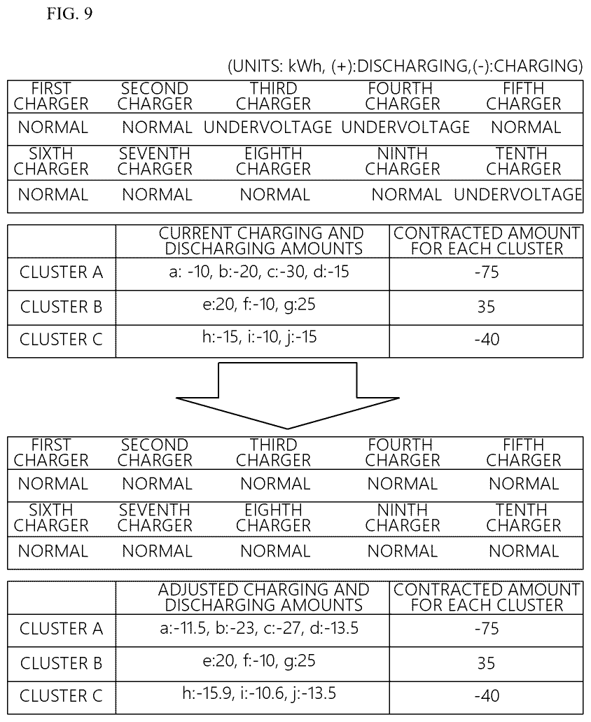

Referring to FIG. 9 together, the fourth processing unit 114 may determine that the undervoltage event occurs in the third charger, the fourth charger, and the tenth charger that are connected to Bus #3. The fifth processing unit 115 may check electric vehicle information connected to the third and fourth chargers and a cluster to which the third and fourth chargers belong and adjust the charging and discharging schedules of the electric vehicles belonging to Cluster A. In addition, the fifth processing unit 115 may check electric vehicle information connected to the tenth charger and a cluster to which the tenth charger belongs and adjust the charging and discharging schedules of the electric vehicles belonging to Cluster C.

The fifth processing unit 115 distributes parts of the charging amounts of the electric vehicles c and d connected to the third and fourth chargers to the electric vehicles a and b connected to the first and second chargers. In addition, the fifth processing unit 115 distributes some of the charging amount of the electric vehicle j connected to the tenth charger to the electric vehicles h and i connected to the eighth and ninth chargers.

After adjusting the charging and discharging schedules, the fifth processing unit 115 checks whether the voltages of the first to tenth chargers are included within the reference voltage range and whether the contracted amount for each cluster is satisfied.

Since voltage abnormality events such as an undervoltage, an overvoltage, and the like occur locally, an accurate position of the charger cannot be identified, but the device for scheduling charging and discharging of an electric vehicle according to the embodiment may readjust the charging and discharging schedules to decrease voltage fluctuation so as to adjust the nominal voltage to be within the range of a distribution system-connected technology. That is, it is possible to reduce the load burden of a specific bus by increasing or decreasing the capacity of the charging and discharging schedules of the electric vehicle connected to the charger at a predetermined ratio and reflecting the increased or decreased amount to the charging and discharging capacity of another electric vehicle in the same cluster.

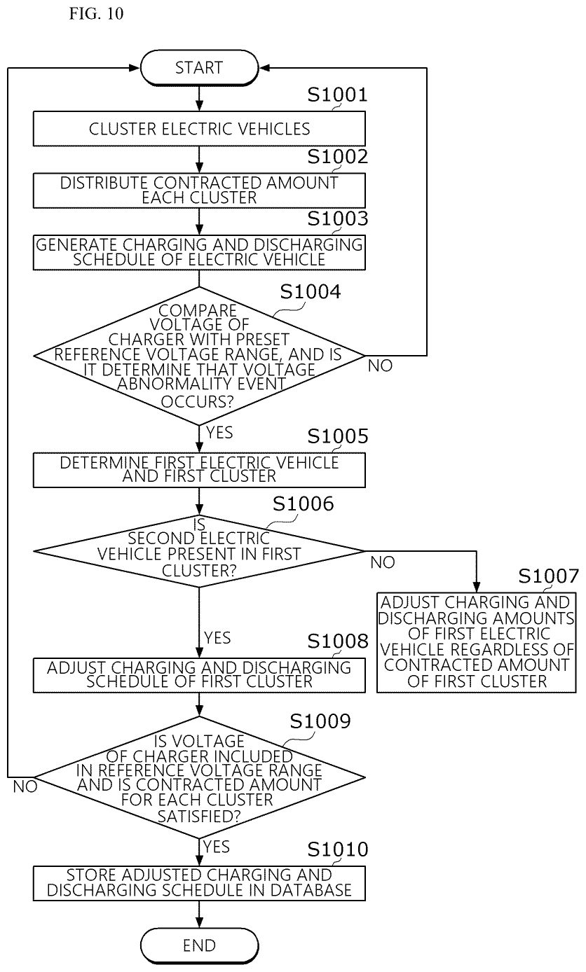

FIG. 10 is a flowchart of a method of scheduling charging and discharging of an electric vehicle according to an embodiment. Referring to FIG. 10, a processor clusters registered electric vehicles (S1001).

Next, the processor distributes the contracted amount received from a demand management business operator server to each cluster (S1002).

Next, the processor generates charging and discharging schedules of an electric vehicle using the contracted amount distributed to each cluster (S1003).

Next, the processor compares a voltage of a charger collected from a charger server with a preset reference voltage range and determines whether a voltage abnormality event occurs. In this case, when the voltage of the charger exceeds the reference voltage range, the processor determines that an overvoltage event occurs, and when the voltage of the charger is below the reference voltage range, the processor determines that an undervoltage event occurs (S1004).

Next, the processor determines a first electric vehicle connected to the charger in which the voltage abnormality event occurs and a cluster to which the first electric vehicle belongs (S1005).

Next, the processor determines whether a second electric vehicle is present in a first cluster (S1006).

When the second electric vehicle is not present in the first cluster, the processor adjusts charging and discharging amounts of the first electric vehicle regardless of the contracted amount of the first cluster and controls the charger to satisfy a reference voltage range condition (S1007).

When the second electric vehicle is present in the first cluster, the processor adjusts charging and discharging schedules of the first cluster (S1008).

For example, when an overvoltage event occurs, the processor adjusts the charging and discharging schedules to distribute at least some of the discharging amount of the first electric vehicle to the second electric vehicle belonging to the first cluster.

Alternatively, when the overvoltage event occurs, the processor adjusts the charging and discharging schedules to distribute at least some of the charging amount of the second electric vehicle belonging to the first cluster to the first electric vehicle.

Alternatively, when an undervoltage event occurs, the processor adjusts the charging and discharging schedules to distribute at least some of the discharging amount of the second electric vehicle belonging to the first cluster to the first electric vehicle.

Alternatively, when the undervoltage event occurs, the processor adjusts the charging and discharging schedules to distribute at least some of the charging amount of the first electric vehicle to the second electric vehicle belonging to the first cluster.

Next, the processor adjusts the charging and discharging schedules and determines whether the voltage of the charger is included within the reference voltage range and whether the cluster-specific contracted amount is satisfied (S1009).

Next, the processor stores the charging and discharging schedules that satisfy the conditions considered in operation S1009 in a database (S1010).

The term “unit” used in the present embodiment may be a software or hardware component such as an FPGA or an ASIC, and the “unit” may perform (e.g., certain) roles. However, the “unit” is not limited to software or hardware. The “unit” may be formed to be disposed in an addressable storage medium and configured to reproduce one or more processors. Therefore, as an example, the “unit” may be components such as software components, object-oriented software components, class components, and task components, processes, functions, attributes, procedures, subroutines, segments of program code, drivers, firmware, microcode, circuits, data, database, data structures, tables, arrays, and variables. Functions provided in the components and “units” may be combined into the smaller number of components and “unit” or separated into additional components and “units.” Additionally, the components and “units” may be implemented to reproduce one or more CPUs in a device or a security multimedia card.

A device and method for scheduling charging and discharging of an electric vehicle according to example embodiments may consider voltage fluctuation occurring in a distribution system during charging and discharging of electric vehicles and (e.g., efficiently) manage power quality.

In addition, the load burden of a bus in which an undervoltage or an overvoltage is predicted may be reduced.

Although the present disclosure has been described above with reference to example embodiments, those skilled in the art may understand that the present disclosure may be modified and changed without departing from the spirit and scope of the present disclosure as described in the appended claims.

What is claimed is:

1. An electrical vehicle control device for scheduling charging and discharging of an electric vehicle, comprising:
a memory storing computer-executable instructions; and
at least one processor configured to access the memory and execute the instructions, wherein the instructions comprise:
clustering, via a first processing unit, a plurality of registered electric vehicles;
distributing, via a second processing unit, a contracted amount of electric received from a demand management business operator server to at least one cluster;
generating, via a third processing unit, a charging and discharging schedule of at least one registered electric vehicle using the contracted amount distributed to the at least one cluster;
comparing, via a fourth processing unit, a voltage of a charger collected from a charger server with a preset reference voltage range and determining whether a voltage abnormality event occurs, wherein the voltage abnormality event occurs when the voltage is outside of the preset reference voltage range; and
adjusting, via a fifth processing unit, a charging and discharging schedule of the at least one registered electric vehicle of the at least one cluster when the voltage abnormality event occurs.

2. The electrical vehicle control device of claim 1, wherein the instructions further comprise controlling, via the fifth processing unit, the voltage of the charger to be included within the reference voltage range through the adjustment of the charging and discharging schedule.

3. The electrical vehicle control device of claim 2, wherein the instructions further comprise adjusting, via the fifth processing unit, the charging and discharging schedule while maintaining the contracted amount for the at least one cluster.

4. The electrical vehicle control device of claim 1, wherein the instructions further comprise determining, via the fourth processing unit, an overvoltage event occurs when the voltage of the charger exceeds the reference voltage range.

5. The electrical vehicle control device of claim 4, wherein the instructions further comprise, when the overvoltage event occurs, distributing, via the fifth processing unit, at least a portion of a discharging amount of a first electric vehicle to a second electric vehicle belonging to a first cluster.

6. The electrical vehicle control device of claim 4, wherein the instructions further comprise, when the overvoltage event occurs, distributing, via the fifth processing unit at least a portion of a charging amount of a second electric vehicle belonging to a first cluster to a first electric vehicle.

7. The electrical vehicle control device of claim 1, wherein the instructions further comprise determining, via the fourth processing unit, an undervoltage event occurs when the voltage of the charger is below the reference voltage range.

8. The electrical vehicle control device of claim 7, wherein the instructions further comprise, when the undervoltage event occurs, distributing, via the fifth processing unit, at least a portion of a discharging amount of a second electric vehicle belonging to a first cluster to a first electric vehicle.

9. The electrical vehicle control device of claim 7, wherein the instructions further comprise, when the undervoltage event occurs, distributing, via the fifth processing unit, at least a portion of a charging amount of a first electric vehicle to a second electric vehicle belonging to a first cluster.

10. The electrical vehicle control device of claim 1, wherein the instructions further comprise, when the fifth processing unit does not control the voltage of the charger to be included within the reference voltage range through the adjustment of the charging and discharging schedule, adjusting, via the fifth processing unit, charging and discharging amounts of a first electric vehicle without maintaining the contracted amount for each cluster.

11. A method of scheduling charging and discharging of an electric vehicle, which is performed by a computing device, a memory storing computer-executable instructions, and at least one processor configured to access the memory and execute the instructions, the method comprising:
performing, by the processor, clustering of registered electric vehicles;
distributing, by the processor, a contracted amount received from a demand management business operator server to each cluster;
generating, by the processor, a charging and discharging schedule of an electric vehicle using the contracted amount distributed to each cluster;
comparing, by the processor, a voltage of a charger collected from a charger server with a preset reference voltage range and determining whether a voltage abnormality event occurs; and
determining, by the processor, a first electric vehicle connected to a charger in which the voltage abnormality event occurs and adjusting a charging and discharging schedule of a first cluster to which the first electric vehicle belongs.

12. The method of claim 11, wherein the adjusting of the charging and discharging schedule includes controlling the voltage of the charger to be included within the reference voltage range through the adjusting of the charging and discharging schedule.

13. The method of claim 12, wherein the adjusting of the charging and discharging schedule includes adjusting the charging and discharging schedule while maintaining the contracted amount for each cluster.

14. The method of claim 11, wherein the determining of whether the voltage abnormality event occurs includes determining that an overvoltage event occurs when the voltage of the charger exceeds the reference voltage range.

15. The method of claim 14, wherein the adjusting of the charging and discharging schedule includes distributing at least a portion of a discharging amount of the first electric vehicle to a second electric vehicle belonging to the first cluster when the overvoltage event occurs.

16. The method of claim 14, wherein the adjusting of the charging and discharging schedule includes distributing at least a portion of a charging amount of a second electric vehicle belonging to the first cluster to the first electric vehicle when the overvoltage event occurs.

17. The method of claim 11, wherein the determining of whether the voltage abnormality event occurs includes determining that an undervoltage event occurs when the voltage of the charger is below the reference voltage range.

18. The method of claim 17, wherein the adjusting of the charging and discharging schedule includes distributing at least a portion of a discharging amount of a second electric vehicle belonging to the first cluster to the first electric vehicle when the undervoltage event occurs.

19. The method of claim 17, wherein the adjusting of the charging and discharging schedule includes distributing at least a portion of a charging amount of the first electric vehicle to a second electric vehicle belonging to the first cluster when the undervoltage event occurs.

20. The method of claim 11, further comprising:
determining the voltage of the charger to be included within the reference voltage range through the adjusting of the charging and discharging schedule; and
adjusting charging and discharging amounts of the first electric vehicle without maintaining the contracted amount for each cluster when the voltage of the charger is not included within the reference voltage range.
